(19) United States
(12) Patent Application Publication
(10) Pub. No.: US 2003/0144014 A1
(43) Pub. Date: Jul. 31, 2003

(54) Method and apparatus for an on-board call

(75) Inventor: David Bruce Kumhyr, Austin, TX (US)

Correspondence Address: Leslie A. Van Leeuwen,, International Business Machines Corporation, Intellectual Property Law Dept. Internal Zip 4054, 11400 Burnet Road, Austin, TX, 78758, US

(73) Assignee: International Business Machines Corporation, Armonk, NY

(21) Appl. No.: 10/062,367

(22) Filed: Jan. 31, 2002

(51) Int. Cl. H04B 7/00; H04Q 7/20

(52) U.S. Cl. 455/465; 455/66; 455/445

(57) ABSTRACT

In a first form, a method for providing telephone service to a passenger on-board an aircraft includes establishing an identity for the passenger. In establishing the passenger identity, an on-board telephone service provider receives communication by an off-board communications means. In another step, information about the passenger's flight is obtained, according to which the on-board telephone service provider receives at least a portion of the flight information from a flight information provider. An on-board telephone is selected for an incoming call responsive to i) the flight information provided by the flight information provider and ii) the passenger identity. In this manner the passenger does not have to activate the on-board telephone nor even contact the telephone service provider prior to receiving an on-board call.

### BACKGROUND

1. Field of the Invention

The present invention relates to communication between a land-based caller and a passenger on-board a vehicle.

2. Related Art

Current, state-of-the-art communication allows passengers on commercial airlines to receive incoming telephone calls while on-board. Airfone and AT&T are two major on-board telephone service providers, collectively serving a number of airlines, such as American Airlines, Delta, Northwest, TWA, Southwest Airlines, United Airlines, etc. In the current art, a passenger can receive telephone calls at his or her airplane seat if the passenger registers with the appropriate on-board telephone service provider to receive calls once on-board the airplane, or at least activates a selected on-board telephone before receiving incoming calls. While this is a valuable service, the current procedure for registering or activating is somewhat time consuming and limiting, particularly considering that if a number of passengers sitting close together wish to register or activate to receive calls on-board, they must take turns accessing a shared telephone. Moreover, according to the current procedure if a passenger does not register for receiving calls on-board or activate a telephone once on-board, then the passenger cannot be reached. Thus a need exists for improvements in providing on-board telephone service.

### SUMMARY OF THE INVENTION

The forgoing need is addressed, in a first form, by a method for providing telephone service to a passenger on-board an aircraft, according to which in one step an identity for the passenger is established. In establishing the passenger identity, an on-board telephone service provider receives communication by an off-board communications means. In another step, information about the passenger's flight is obtained, according to which the on-board telephone service provider receives at least a portion of the flight information from a flight information provider. An on-board telephone is selected for an incoming call responsive to i) the flight information provided by the flight information provider and ii) the passenger identity. In this manner the passenger does not have to activate the on-board telephone nor even contact the telephone service provider prior to receiving an on-board call.

Objects and advantages of the invention will become apparent upon reading the following detailed description and upon reference to the accompanying drawings.

### BRIEF DESCRIPTION OF THE DRAWINGS

FIG. 1 illustrates, in block diagram form, aspects concerning the telephone service for a passenger on-board an aircraft, according to an embodiment of the invention.

FIG. 2 illustrates, also in block diagram form, additional and alternative aspects concerning the telephone service, according to an embodiment in which, among other things, the passenger sets up an account with an onboard telephone service provider prior to a flight.

FIG. 3 illustrates, also in block diagram form, additional and alternative aspects concerning the telephone service, according to an embodiment in which, among other things, the passenger forwards his telephone to the onboard telephone service provider.

FIG. 4 illustrates, also in block diagram form, additional and alternative aspects concerning the telephone service, according to an embodiment in which, among other things, a caller calls the on-board telephone service provider and provides passenger identification, and flight information, including airline (aka “airline”) identification, flight identification and passenger seat assignment.

FIG. 5 illustrates, also in block diagram form, additional and alternative aspects concerning the telephone service, according to an embodiment in which, among other things, the on-board telephone service provider queries a number of airline airlines with the passenger's identity in order to locate the aircraft for the passenger.

### DETAILED DESCRIPTION OF THE PREFERRED EMBODIMENT

The claims at the end of this application set out novel features which applicants believe are characteristic of the invention. The invention, a preferred mode of use, objectives and advantages, will best be understood by reference to the following detailed description of an illustrative embodiment read in conjunction with the accompanying drawings.

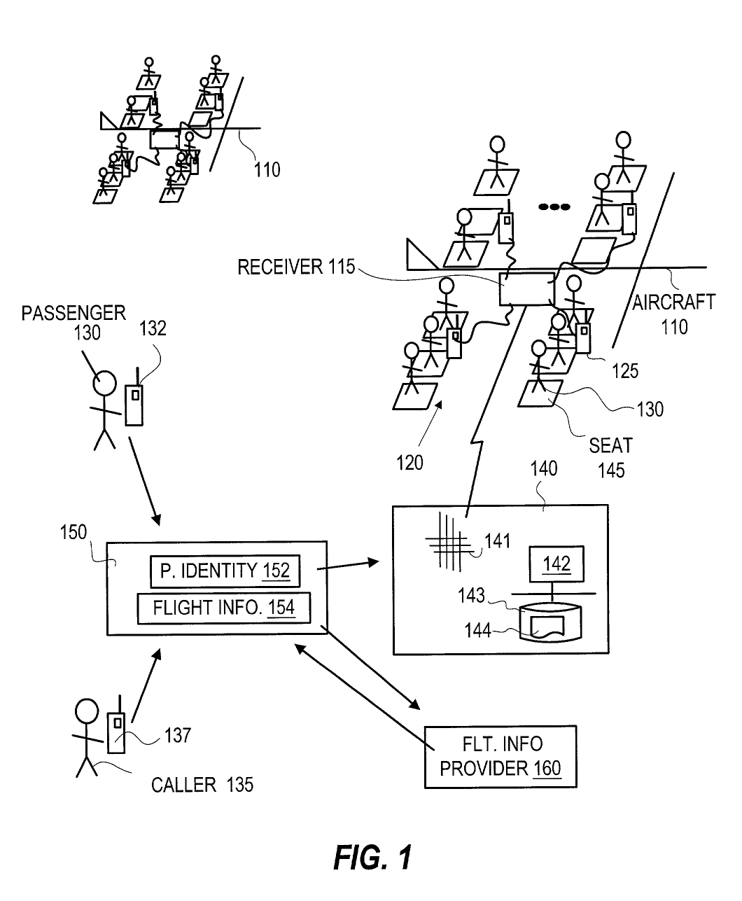

Referring now to FIG. 1, aspects are illustrated concerning telephone service for a passenger on-board an aircraft, according to an embodiment of the invention. As illustrated, an onboard telephone service provider (“OTSP”) 140 has a network 141, a processor 142, memory 143 and a computer program 144 within memory 143 operable with the processor 142 for receiving a telephone call from a caller 135 to a passenger 130 on-board an aircraft 110 and directing the call to a receiver 115 on-board the aircraft 110, and from the receiver 115 to a selected telephone 125 on-board. The OTSP receives information 150 which enables the OTSP to select the receiver 115 from among a number of receivers on a number of respective other aircraft 110 and to select the telephone 125 from among a number of telephones 120 on-board the selected aircraft 110. The telephone 125 is selected because it is the nearest one of the telephones 120 to the passenger's seat 145.

The information 150 includes information establishing an identity 152 for the passenger 130, and information 154 about the flight, as will be further described in subsequent FIG's. The information 150 is provided from one or more of a number of sources, which may include the caller 135, a flight information provider 160 or the passenger 130 him or herself. The flight information provider 160 may be, for example, an airline or an independent flight information provider having access to airspace information. At least some of the information 150 is provided by an off board communication means, i.e. some means other than one of the onboard telephones 120, such as a telephone other than one of the onboard telephones 120, an Internet communications link, a pager, etc. For example, in the illustration, the passenger 130 provides some of the information 150 before boarding the aircraft 110 by means of one of the passenger's telephones 132, and the caller 135 provides some of the information by means of one of the caller's telephones 137. (It should be understood that although the term “off board communication means” is used, this does not exclude some of the information 150 being provided by some communication means onboard the aircraft, as long as the communication is not by one of the OTSP 140 telephones 120. For example, the passenger 130 could provide some of the information 150 by the passenger's cell telephone while the passenger is onboard the aircraft 110.)

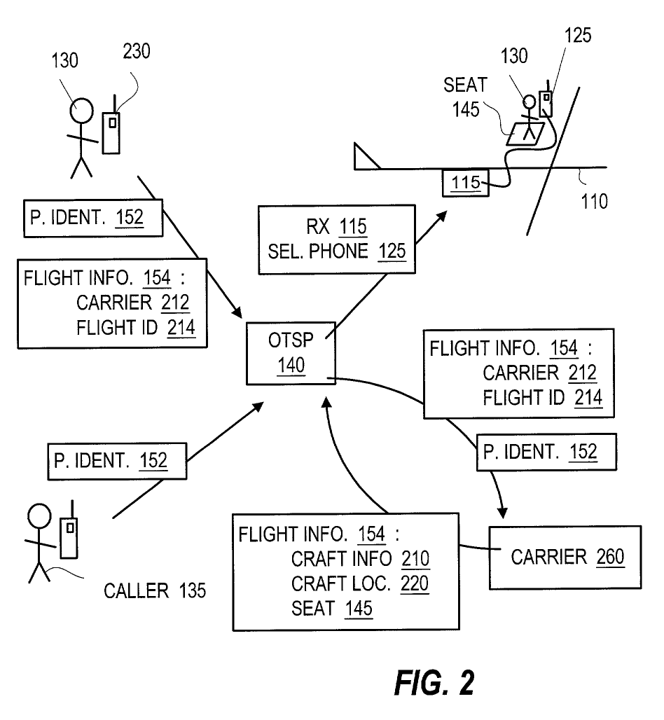

Referring now to FIG. 2, additional and alternative aspects are illustrated concerning telephone service for a passenger on-board an aircraft, according to an embodiment of the invention. In FIG. 2, prior to the flight, the passenger 130 sets up an account with the OTSP 140, which includes providing passenger identification 152, including the name of the passenger 130. For example, the passenger may even do this account set up with the OTSP indirectly, such as by setting up the account through the passenger's frequent-flier profile with the airline, in which case the airline communicates the information to the OTSP on behalf of the passenger. The passenger may also select a personal identifier, such as a personal identification number, as additional or alternative passenger identification 152. The personal identifier may be used as an additional security precaution, particularly for the case where the passenger agrees in advance to pay for incoming calls. In other embodiments there are other alternatives. For example, rather than the passenger affirmatively setting up an account, the airline may automatically forward the passenger information to the OTSP unless the passenger opts out when booking the flight. Or the passenger may book the flight through a travel agency, such as over the Internet, and may click a box agreeing to have the agent forward passenger information.

In the embodiment of FIG. 2, the passenger also provides the OTSP 140 with flight information 154, including identity 212 of the airline 260 and the flight identification 214, for example, flight number. Then, for an incoming call, according to this embodiment, the caller 135 calls the on-board telephone service provider 140, such as by calling a toll-free, “800” number, and provides passenger identification 152, such as the name of the passenger 130.

The OTSP 140 then provides the passenger identification 152, airline identification 212 and flight identification 214 to the airline 260, which is the flight information provider 160 (FIG. 1) in this case. In response, the airline 260 returns to the OTSP 140 the current location 220 for the aircraft 110 on that flight 214, the seat assignment 145 for the passenger 130 and information 210 about the arrangement of the aircraft 110, including the layout of the seats, i.e., an association with one or more of the seats on the aircraft 110 for each telephone 120 (FIG. 1). The OTSP 140 uses the aircraft 110 location 220 for finding the receiver 115 within the OTSP's network, and uses the seat assignment 145 and the craft information 210 about the layout of the seats to select the telephone 125 nearest the seat 145 for the passenger 130.

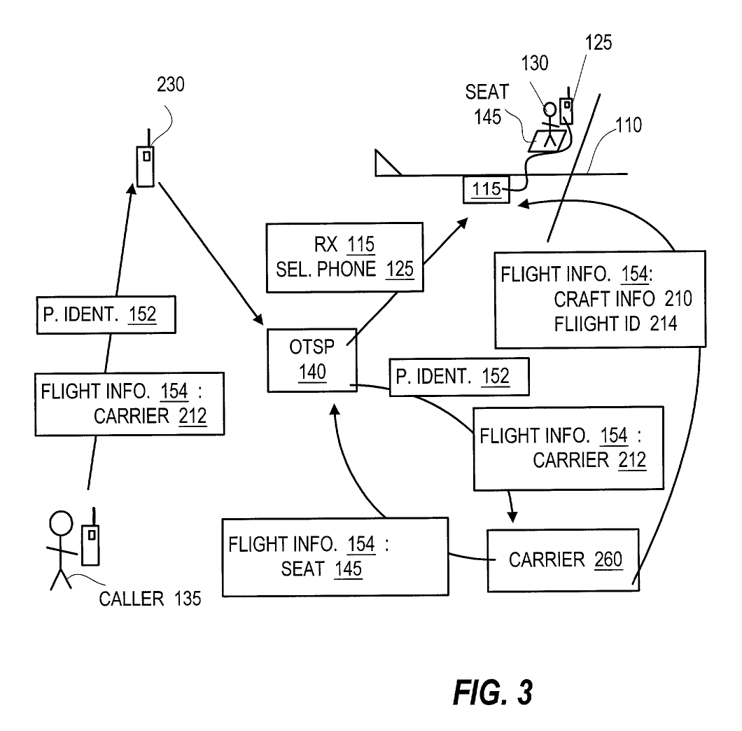

Referring now to FIG. 3, additional and alternative aspects are illustrated concerning on-board telephone service, according to an embodiment. In FIG. 3, the passenger 130 forwards his telephone 230 to the OTSP 140, so that incoming calls for the passenger 130 are received by the OTSP 140. In this embodiment, this is the only communication from the passenger 130 to the OTSP 140 for establishing the passenger identity 152. That is, the passenger identity 152 is initially established merely by the OTSP receiving an indication that the passenger's off-board telephone line is forwarding to the on-board telephone service provider.

In this embodiment, airline 260 provides flight information 154 directly to each OTSP 140 receiver on-board each respective one of a number of aircraft. That is, the receiver 115 on-board an aircraft 110 is programmed by the airline 260 at the beginning of each flight with the flight identification 214. Also, the receiver 115 is preprogrammed with information 210 for the craft 110 about the layout of the seats.

Then, for an incoming call, the caller 135 is told by the OTSP 140 that the called party has forwarded his or her telephone 230 to an OTSP, and the caller 135 provides to the OTSP 140 the passenger identity 152, i.e., passenger name, and part of the flight information 154, e.g., identity 212 of the airline 260. OTSP 140 provides the passenger identification 152 and airline identity 212 to the airline 260, in order to locate the passenger 130. In response, the airline returns to the OTSP 140 the seat assignment 145 for the passenger 130. The OTSP 140 uses the aircraft 110 flight identification 214 to query its receivers on all aircraft and find the receiver 115 on-board the same aircraft 110 carrying the passenger 130. The receiver 115 uses the seat assignment 145 passed to it by the OTSP and its preprogrammed craft information 210 (about the layout of the seats) to select the telephone 125 nearest the seat 145 for the passenger 130.

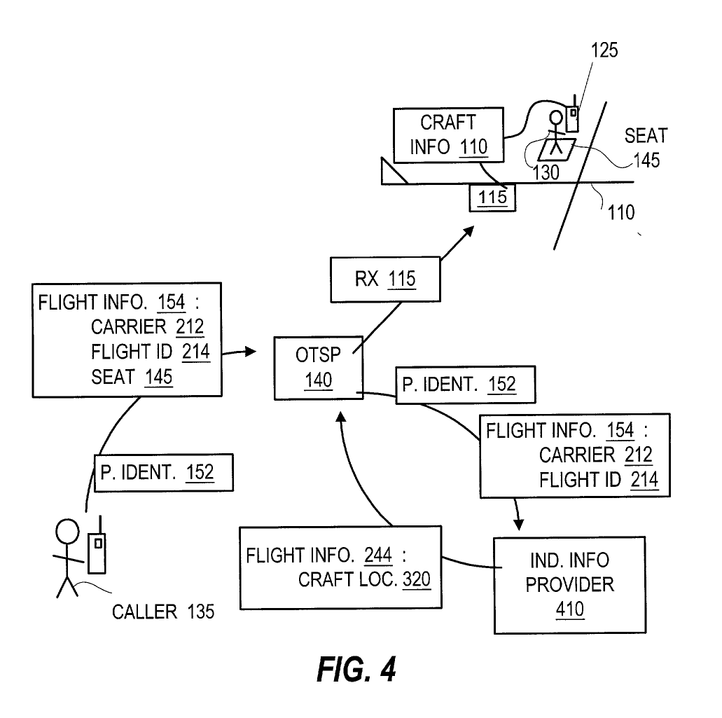

Referring now to FIG. 4, additional and alternative aspects are illustrated concerning on-board telephone service, according to an embodiment. In this embodiment, the passenger 130 does not communicate at all with the OTSP prior to receiving an incoming telephone call on-board the aircraft 110. For the incoming call, according to this embodiment the caller 135 calls the on-board telephone service provider 140 and provides passenger identification 152, and flight information 154, including airline identification 212, flight identification 214 and seat assignment 145. The OTSP 140 then provides passenger identification 152 and flight identification 214 to the independent flight information provider 410. In response, the information provider 410 returns to the OTSP 140 the current location 220 for the aircraft 110. In this embodiment, information 210 about the layout of the seats and telephones on the aircraft 110 is preprogrammed in the OTSP 140 receiver 115 or associated OTSP equipment that communicates with the receiver. The OTSP 140 uses the aircraft 110 location 220 for finding the receiver 115, and the receiver 115 or associated equipment uses the seat assignment 145 and the craft information 210 to select the telephone 125 nearest the seat 145 for the passenger 130.

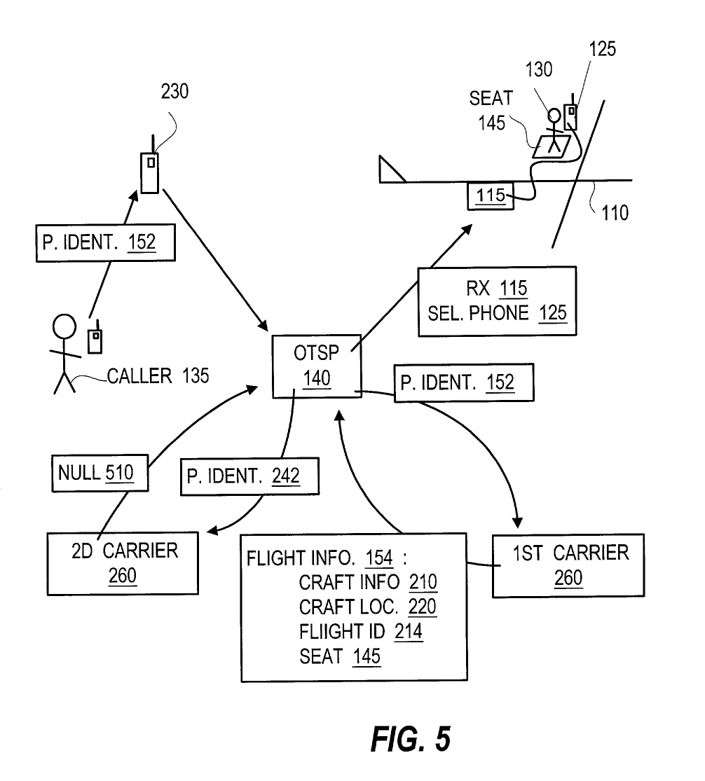

Referring now to FIG. 5, additional and alternative aspects are illustrated concerning on-board telephone service, according to an embodiment. In FIG. 5, the passenger 130 again forwards his telephone 230 to the OTSP 140, so that incoming calls for the passenger 130 are received by the OTSP 140. Then, for an incoming call, the caller 135 provides to the OTSP 140 the passenger identity 152. However, in this case the caller 135 does not provide any of the flight information 154. The OTSP 140 therefore queries a number of airlines 260 with the passenger identity 152 in order to locate the aircraft 110 for the passenger 130. In the illustration, one of the carriers 260 returns a null response 510 and one of the carriers 260 returns the flight information 154. The OTSP 140 uses the flight information 154 to select the receiver 115 on-board the correct aircraft 110 and the telephone 125 for the seat 145 assigned to the passenger 130.

The description of the present embodiments have been presented for purposes of illustration, but are not intended to be exhaustive or to limit the invention to the forms disclosed. Many additional aspects, modifications and variations are also contemplated and are intended to be encompassed within the scope of the following claims. For example, while certain aspects of the present invention relating to the OTSP have been described in the context of a fully functioning data processing system, those of ordinary skill in the art will appreciate that processes of the present invention are capable of being distributed in the form of a computer readable medium of instructions in a variety of forms and that the present invention applies equally regardless of the particular type of signal bearing media actually used to carry out the distribution. Examples of computer readable media include RAM, flash memory, recordable-type media, such a floppy disk, a hard disk drive, a ROM, and CD-ROM, and transmission-type media such as digital and analog communications links, e.g., the Internet.

In another example, in the embodiments described in detail herein the passenger telephone has been on-board an aircraft. It should be understood that in other embodiments the telephone is on-board some other vehicle, such as a bus, train or boat. Accordingly, in the claims that follow the term “aircraft” is meant to encompass other vehicles besides a conventional aircraft, the term “flight” is meant to encompass a passage on any such vehicle, etc. Also, in the embodiments described in detail herein an on-board telephone was selected due to being the nearest one of the telephones to the called passenger's seat. In an alternative, the telephone is merely on the same row as the passenger's seat 145. Alternatively, the telephone is on a row adjacent to the passenger's seat.

It should be appreciated that various aspects of the information conmmunicated to the OTSP for directing a call to a passenger could be communicated in a somewhat different sequence and manner and could thereby provide additional or different advantages than described in detail herein and nevertheless be within the spirit and scope of the invention. For example, the passenger may end up in a seat that was not originally anticipated, nor even accurately indicated on the flight manifest which the carrier may use to provide information to the OTSP, in which case the passenger may need to communicate to the OTSP, or at least to the OTSP's receiver on-board the aircraft, to update the seat assignment information. While this exceptional case shares some similarity with the current state of the art with respect to the requirement of on-board telephone activation, it should also be appreciated that the mere updating of a seat assignment as in the present invention may be quicker and less burdensome than setting up an account or activating a telephone as must be done in the current art. Moreover, the seat assignment may be updated by use of the passenger's cell phone if circumstances permit.

In another example, in an embodiment that combines aspects of FIG. 4, in which the caller 135 provides the carrier identification 212, flight identification 214 and seat assignment 145, and aspects of FIG. 3, in which the carrier 260 initializes the OTSP 140 receiver 115 with flight identification 214, it is not necessary for the OTSP 140 to contact a flight information provider 160 (FIG. 1) (i.e., independent information provider 410 (FIG. 4) or carrier 260 (FIG. 3)) after receiving the incoming call from caller 135. In this alternative, as in FIG. 3, the OTSP 140 uses the aircraft 110 flight identification 214 to query all its aircraft-based receivers and find the receiver 115 on-board the same aircraft 110 carrying the passenger 130. The receiver 115 uses the seat assignment 145 passed to it by the OTSP and its preprogrammed craft information 210 (about the layout of the seats) to select the telephone 125 nearest the seat 145 for the passenger 130.

To reiterate, many additional aspects, modifications and variations are also contemplated and are intended to be encompassed within the scope of the following claims. Moreover, it should be understood that steps in the following claims do not necessarily have to be performed in the particular sequence in which they are set out.

What is claimed is:

1. A method for providing telephone service to a passenger on-board an aircraft, the method comprising the steps of:
a) establishing an identity for the passenger, including the step of:
receiving, by an on-board telephone service provider, communication by an off-board communications means;
b) obtaining information about the passenger's flight, including the step of:
receiving, by the on-board telephone service provider, at least a portion of the flight information from a flight information provider other than the passenger or a caller; and
c) selecting an on-board telephone for an incoming call to the passenger, the selecting being responsive to i) the flight information provided by the flight information provider and ii) the passenger identity.

2. The method of claim 1, wherein the flight information received from the flight information provider includes location of the aircraft.

3. The method of claim 1, wherein the step of receiving at least a portion of the flight information from a flight information provider includes the flight information provider communicating an identifier for the flight to a receiver for on-board telephone service.

4. The method of claim 1, wherein the flight information received from the flight information provider includes a seat assignment for the passenger.

5. The method of claim 4, wherein the flight information received from the flight information provider includes information about layout of seats and telephones on the aircraft for the flight, and step c) comprises the step of:
determining an association between a telephone and an assigned seat responsive to the aircraft information.

6. The method of claim 1, wherein the passenger has an off-board telephone line, and step a) comprises the step of:
receiving an indication by the on-board telephone service provider that the passenger's off-board telephone line is forwarding to the on-board telephone service provider.

7. The method of claim 1, wherein step a) comprises the step of:
receiving passenger identification from the caller.

8. The method of claim 1, wherein step b) comprises the step of:
receiving flight identification from the caller.

9. The method of claim 1, wherein step b) comprises the step of:
receiving passenger seat assignment from the caller.

10. The method of claim 1, wherein the flight is an airline flight, and the flight information provider includes the airline.

11. The method of claim 1, wherein the flight is an airline flight, and the flight information provider includes a third party information provider.

12. A method for providing telephone service on-board an aircraft, the method comprising the steps of:
a) establishing a passenger identity, including the step of:
receiving, by an on-board telephone service provider, communication by an off-board communications means;
b) obtaining information about the passenger's flight, including a seat assignment for the passenger, wherein step b) comprises the step of:
receiving, by the on-board telephone service provider, information about the flight from a flight information provider other than the passenger or a caller, the flight information including a flight identification or location of the aircraft; and
c) directing an incoming call for the passenger to a selected telephone on-board the aircraft, including the steps of:
selecting a passage responsive to the passenger identity for the incoming call;
selecting a receiver for a group of telephones on-board the aircraft responsive to the flight identification or the aircraft location; and
selecting the on-board telephone responsive to the seat assignment and the information about the craft.

13. The method of claim 12, wherein the passenger has an off-board telephone line, and step a) comprises the step of:
receiving an indication by the on-board telephone service provider that the passenger's off-board telephone line is forwarding to the telephone service provider.

14. The method of claim 10, wherein step a) comprises the step of:
receiving passenger identification from the caller.

15. The method of claim 12, wherein at least a portion of the flight information is received from the caller.

16. The method of claim 12, wherein the flight is an airline flight, and the flight information provider includes the airline.

17. The method of claim 12, wherein the flight is an airline flight, and the flight information provider includes a third party information provider

18. An apparatus for providing telephone service on-board an aircraft, the apparatus comprising:
a number of telephones on-board a number of aircraft, including telephones associated with respective rows of seats on each respective aircraft;
a network for receiving a call for a passenger and transmitting the call to a selected one of the telephones on a selected one of the aircraft;
a processor; and
memory, wherein the memory has a computer program operable with the processor for performing the steps of:
a) establishing a passenger identity;
b) receiving, by the on-board telephone service provider, information about the flight from a flight information provider other than the passenger or a caller, the flight information including a flight identification or location of the aircraft; and
c) directing an incoming call for the passenger to a selected on-board telephone, including the steps of:
selecting the aircraft responsive to the flight identification or aircraft location for the incoming call; and
selecting the on-board telephone responsive to the seat assignment.

19. The apparatus of claim 18, wherein the passenger has an off-board telephone line, and step a) comprises the step of:
receiving an indication by the on-board telephone service provider that the passenger's off-board telephone line is forwarding to the telephone service provider.

20. The apparatus of claim 18, wherein step a) comprises the step of:
receiving passenger identification from the caller.

21. The apparatus of claim 18, wherein at least a portion of the flight information is received from the caller.

22. The apparatus of claim 18, wherein the flight is an airline flight, and the flight information provider includes the airline.

23. The apparatus of claim 18, wherein the flight is an airline flight, and the flight information provider includes a third party information provider.

24. A computer program product for providing telephone service to a passenger on-board an aircraft, the method comprising the steps of:
first instructions for establishing an identity for the passenger, including instructions for receiving, by an on-board telephone service provider, communication by an off-board communications means;
second instructions for obtaining information about the passenger's flight, including instructions for receiving, by the on-board telephone service provider, at least a portion of the flight information from a flight information provider other than the passenger or a caller; and
third instructions for selecting an on-board telephone for an incoming call to the passenger, the selecting being responsive to i) the flight information provided by the flight information provider and ii) the passenger identity.

25. The computer program product of claim 24, wherein the flight information received from the flight information provider includes location of the aircraft.

26. The computer program product of claim 24, wherein at least a portion of the flight information received from a flight information provider includes an identifier for the flight.

27. The computer program product of claim 24, wherein the flight information received from the flight information provider includes a seat assignment for the passenger.
